(19) United States
(12) Patent Application Publication
(10) Pub. No.: US 2014/0082548 A1
(43) Pub. Date: Mar. 20, 2014

(54) ELECTRONIC DEVICE AND METHOD FOR SWITCHING DESKTOPS

(71) Applicant: HON HAI PRECISION INDUSTRY CO., LTD., New Taipei (TW)

(72) Inventors: CHUN-KAI WU, New Taipei (TW); I-CHIN HUNG, New Taipei (TW); CHIA-CHING CHEN, New Taipei (TW); CHUNG-I LEE, New Taipei (TW)

(21) Appl. No.: 13/929,813

(22) Filed: Jun. 28, 2013

(30) Foreign Application Priority Data
Sep. 20, 2012 (TW) 101134567

(51) Int. Cl. G06F 3/0481

(52) U.S. Cl. CPC G06F 3/0481
USPC 715/778

(57) ABSTRACT

In a method for switching desktops of an electronic device, a plurality of desktop application groups and desktops are preset to corresponding preset position ranges. A current position of the electronic device is determined according to acquired position information from a global position system. When the electronic device is located in one of the preset position ranges, the method determines a position range that the current position is in, and determines a desktop application group and a desktop correspondingly. When the determined desktop is different from a current desktop of the electronic device, the method switches the current desktop to the determined desktop, and displays icons of the determined desktop application group on the determined desktop of the electronic device.

### BACKGROUND

1. Technical Field

Embodiments of the present disclosure relate to desktop management technology, and particularly to an electronic device and method for switching desktops using the electronic device.

2. Description of Related Art

A desktop of an electronic device may have a plurality of icons of different applications. An application may be invoked quickly by clicking an icon of the application shown on the desktop. As more and more applications are installed on the electronic device, more icons may be added to the desktop. It is inconvenient for users to select a desired icon to invoke an application.

In addition, a user may need to execute different applications when the user is at different locations, such as an office or a home. An efficient method for providing different kinds of icons on the desktop according to different locations of the electronic device is needed. And, an improved method for switching desktops is desired.

### BRIEF DESCRIPTION OF THE DRAWINGS

FIG. 1 is a block diagram of one embodiment of an electronic device including a switching system.

FIG. 2 is a schematic diagram of position ranges set by the switching system.

FIG. 3 is a schematic diagram of a desktop application group set by the switching system.

FIG. 4 is a flowchart of one embodiment of a method for setting a plurality of desktops of the electronic device.

FIG. 5 is a flowchart of one embodiment of a method for switching desktops using the switching system.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

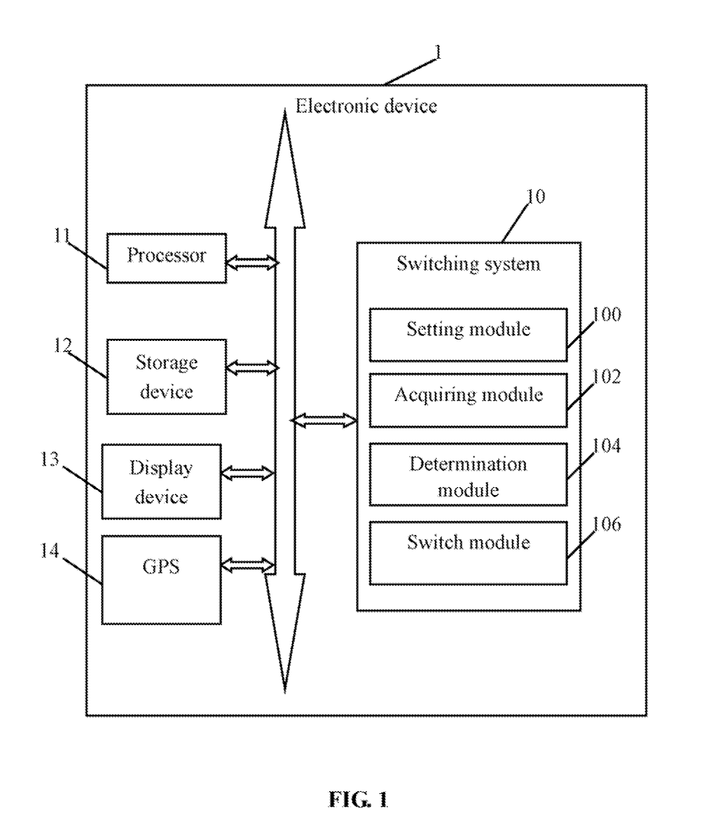

FIG. 1 is a block diagram of one embodiment of an electronic device 1 including a switching system 10. The electronic device 1 further includes at least one processor 11, a storage device 12, a display device 13, and a global position system (GPS) 14. FIG. 1 illustrates only one example of the electronic device 1 that may include more or fewer components than illustrated, or have a different configuration of the various components.

In some embodiments, the electronic device 1 may be a mobile phone, a tablet computer, a personal digital assistant, a notebook computer, or any other device. The switching system 100 may preset a plurality of personalized desktops corresponding to different positions, and switch between the personalized desktops when a position of the electronic device 1 is changed. The personalized desktops may include different application icons.

In one embodiment, the switching system 10 may include computerized instructions in the form of one or more programs that are executed by the at least one processor 11 and stored in the storage device 12. The storage device 12 stores one or more programs, such as operating systems, applications of the electronic device 1, and various data, such as a plurality of maps. In some embodiments, the storage device 12 may be an external storage card, such as a memory stick, a smart media card, a compact flash card, a secure digital card, or any other type of memory storage device.

The display device 13 may be a liquid crystal display (LCD) or a touch-sensitive display (a capacitive touch panel), for example. The GPS 14 may be used to locate the position of the electronic device 1, and provide position information of the electronic device 1. In some embodiments, the position information may include, but is not limited to coordinate information including altitude, longitude, and latitude, map information, descriptions of the position (e.g., A city, B road). The map information provided by the GPS 14 may be a navigation map of a designated position, or a map including highlighted information. For example, a user of the electronic device 1 may mark or tag on the map to highlight a current position, or the designated position.

In one embodiment, the switching system 10 may include one or more modules, for example, a setting module 100, an acquiring module 102, a determination module 104, and a switch module 106. In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

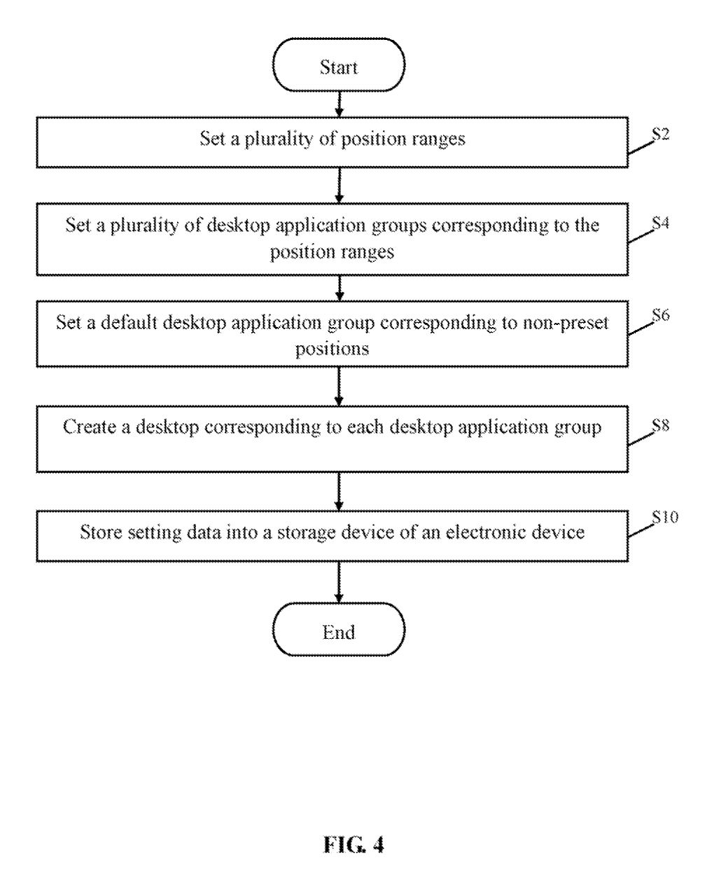

FIG. 4 is a flowchart of one embodiment of a method for setting a plurality of desktops of the electronic device 1, by using the switching system 10. Depending on the embodiment, additional steps may be added, others removed, and the ordering of the steps may be changed.

In step S2, the setting module 100 sets a plurality of position ranges. In some embodiments, the setting module 100 may set the position ranges by following different kinds of methods. In a first embodiment, the setting module 100 may preset a radius according to user input data, and preset a circle based on the radius and inputted coordinates to be the position ranges. The inputted coordinates is determined to be a center of the circle having the preset radius. The inputted coordinates of the center may be coordinates including altitude, longitude, and latitude, or coordinates of a selected position on one of the maps stored in the storage device 12. For example, the setting module 100 recognizes the selected position on the map in response to receiving a click, tap or touch operation of a user on the map, determines the selected position to be the center and determines the coordinates of the center, and then determines the position range.

In a second embodiment, the setting module 100 may preset a length of diagonals, and preset a rectangle based on the length of the diagonal and inputted coordinates of an intersection point of the diagonals to be the position ranges. The intersection point of the diagonals also can be determined by clicking a position on a selected map stored in the storage device 12.

In a third embodiment, the setting module 100 may provide a drawing function for the user to draw images on the selected map stored in the storage device 12, and determine the drawn images to be one or more position ranges by recognizing edges of the drawn images. For example, the edges of the drawn images may be recognized by determining coordinates of a specific number of points on the edges.

In other embodiments, the setting module 100 may preset the position ranges according to user input data directly. For example, the user may input one or more position coordinates to preset the position ranges.

The setting module 100 may provide a plurality of setting modes for the user to select one or more setting modes for inputting relevant data, to preset the position ranges as mentioned above.

In step S4, the setting module 100 sets a plurality of desktop application groups corresponding to the plurality of position ranges. Each of the position ranges may correspond to one desktop application group. In some embodiments, each of the desktop application groups include multiple applications whose icons are shown on a corresponding desktop.

In step S6, the setting module 100 sets a default desktop application group corresponding to non-preset positions. In some embodiments, the non-preset positions represent positions that are not within the plurality of position ranges.

In step S8, the setting module creates a desktop corresponding to each of the plurality of desktop application groups, and creates a default desktop corresponding to the default desktop application group. Each of the desktops (including the default desktop) may include icons of applications in a corresponding desktop application group. In some embodiments, applications commonly used in a specific position range are selected into a desktop application group corresponding to the specific position range. When the user is at the specific position range, a corresponding desktop is displayed on the display device 13. Thus, the user may select a commonly used application using a corresponding icon shown on the desktop.

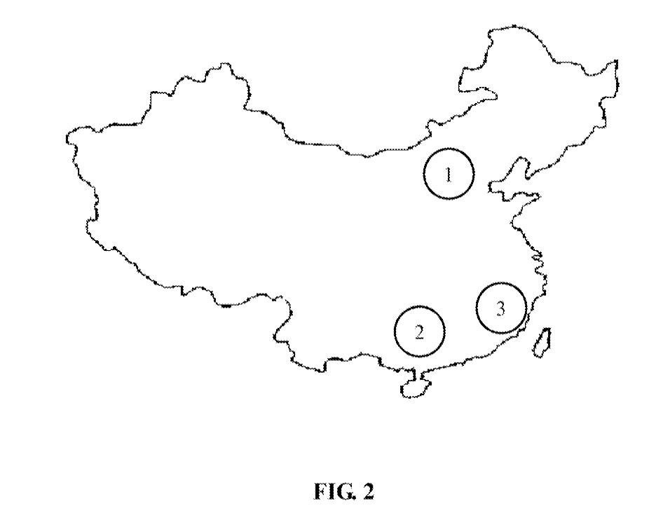

As shown in FIG. 2, there are three circles shown on a map, such as a first position range, a second position range, and a third position range. Supposing that the first position range represents a first working position of the user, the second position range represents a second working position of the user, and the third position range represents a family position of the user. A first desktop application group and a second desktop application group corresponding to the first and second position ranges respectively may include applications commonly used in the office, such as a presentation application, a word application, for example. A third desktop application group corresponding to the third position range may include applications commonly used in the family.

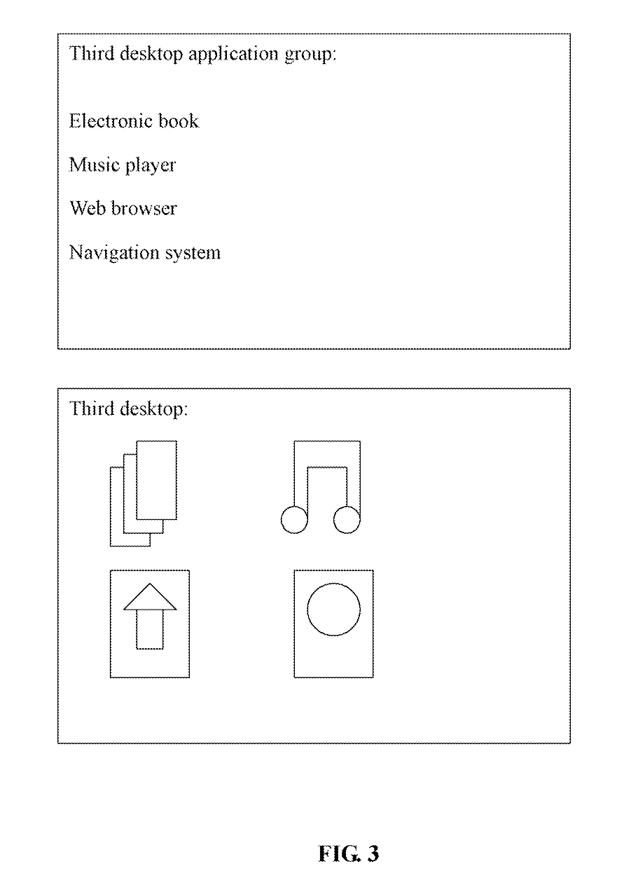

In some embodiments, the switching system 10 may display a different desktop on the display device 13 when the user is in different position ranges, to provide different desktop applications for the user to select conveniently. FIG. 3 is a schematic diagram of an exemplary desktop application group. The third desktop application group corresponding to the third position range is shown in FIG. 3. The third desktop application group includes the following applications, such as an electronic book, a music player, a web browser, and a navigation system.

In some embodiments, the setting module 100 may name each of the desktops or the default desktop, each of the desktop application groups or the default desktop application group, and each of the position ranges.

In step S10, the setting module stores the position ranges, the desktop application groups, the default application group, and corresponding desktops into the storage device 12.

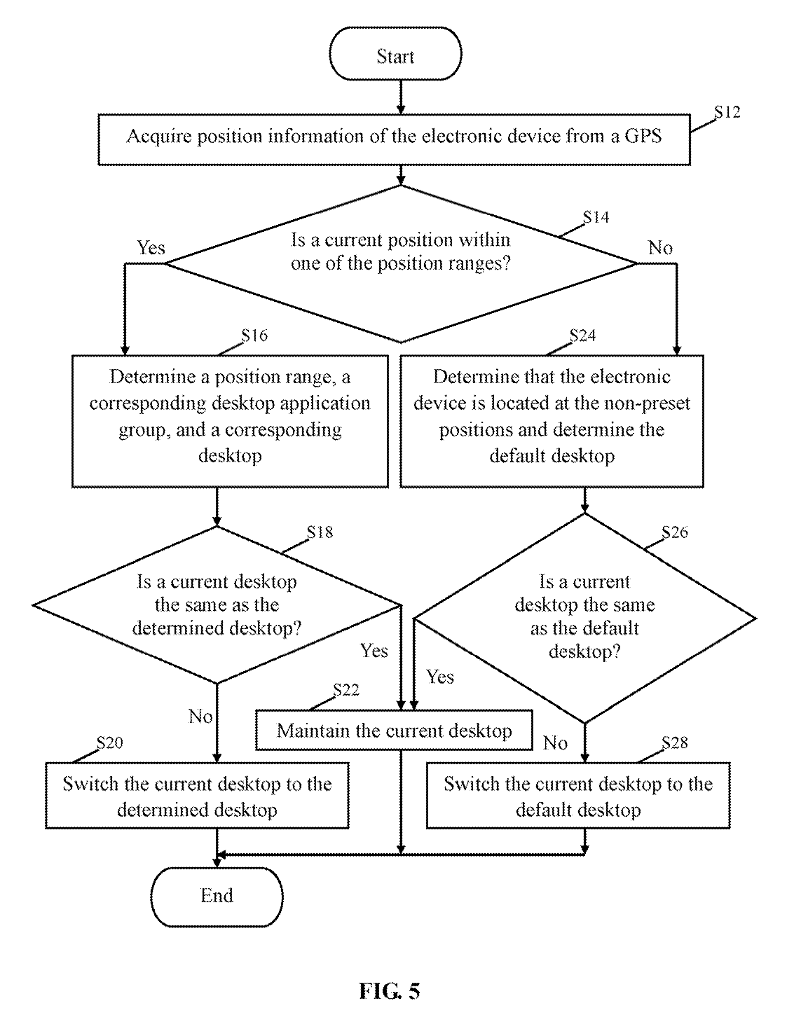

FIG. 5 is a flowchart of one embodiment of a method for switching desktops using the switching system 10. Depending on the embodiment, additional steps may be added, others removed, and the ordering of the steps may be changed.

In step S12, the acquiring module 102 acquires position information of a current position of the electronic device 1 from the GPS 14.

In step S14, the determination module 104 determines whether the current position of the electronic device 1 is within one of the position ranges. When the current position of the electronic device 1 is within one of the position ranges, step S16 is executed. When the current position of the electronic device 1 is not within any position range, step S24 is executed.

In step S16, the determination module 104 determines a position range that the current position is in, and determines a desktop application group and a desktop corresponding to the determined position range.

In step S18, the switch module 106 determines whether a current desktop of the electronic device 1 is the same as the determined desktop. When the current desktop is different from the determined desktop, step S20 is executed. When the current desktop is the same as the determined desktop, step S22 is executed.

In step S20, the switch module 106 switches the current desktop to the determined desktop, and displays icons of the determined desktop application group on the determined desktop of the electronic device 1, then the procedure ends.

In step S22, the switch module 106 maintains the current desktop of the electronic device 1, and the procedure ends.

When the current position of the electronic device 1 is not within any position range, in step S24, the determination module 104 determines that the electronic device 1 is located at the non-preset positions, and determines the default desktop application group and the default desktop, then the procedure goes to step S26.

In step S26, the switch module 106 determines whether a current desktop of the electronic device 1 is the same as the default desktop. When the current desktop is the same as the determined desktop, the procedure goes to step S22, that is, the switch module 106 maintains the current desktop of the electronic device 1. When the current desktop is different from the default desktop, step S28 is executed.

In step S28, the switch module 106 switches the current desktop to the default desktop, and displays icons of the default desktop application group on the default desktop of the electronic device 1, then the procedure ends.

In other embodiments, the setting module 100 may further set an updating frequency, which may be followed by the acquiring module 102 or the determination module 104. For example, the acquiring module 102 may acquire position information from the GPS 14 according to the updating frequency.

For another example, the acquiring module 102 may acquire the position information of the electronic device 1 according to original setting (e.g., 5 seconds), and the determination module 104 may determine whether the current position of the electronic device is changed according to the updating frequency and refreshed position information of the electronic device acquired from the GPS.

The acquiring module 102 determines an updated current position (hereinafter referred to as “the new position”) of the electronic device 1 according to the updating frequency and the refreshed position information, and determines whether the new position is the same as a previous position of the electronic device 1. If the new position is different from the previous position, such as the new position is within another position range or is changed to be a non-preset position, the switch module 106 switches between the preset desktops correspondingly according to the new position of the electronic device 1.

In other embodiments, when the electronic device 1 is located at the non-preset positions, no more operation needs to be executed, the procedure may end directly. That is, no matter whether the current desktop is the default desktop, the current desktop is maintained, and no switch is executed.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for switching desktops of an electronic device, the electronic device comprising a processor and a global position system (GPS), the method comprising:
setting a plurality of position ranges, and setting a plurality of desktop application groups corresponding to the plurality of position ranges;
creating a desktop corresponding to each of the plurality of desktop application groups;
acquiring position information of the electronic device from the GPS;
determining a current position of the electronic device according to the acquired position information;
determining a position range that the current position is in, when the current position is determined to be in one of the plurality of position ranges;
determining a desktop application group and a desktop corresponding to the determined position range of the electronic device using the processor; and
when the determined desktop is different from a current desktop of the electronic device, switching the current desktop to the determined desktop, and displaying icons of the determined desktop application group on the determined desktop of the electronic device.

2. The method according to claim 1, further comprising:
setting an updating frequency, and determining whether the current position of the electronic device is changed according to the updating frequency and refreshed position information of the electronic device acquired from the GPS.

3. The method according to claim 1, further comprising:
setting a default desktop application group corresponding to non-preset positions that are not within the plurality of position ranges; and
setting a default desktop corresponding to the default desktop application group.

4. The method according to claim 3, further comprising:
determining that the electronic device is located at the non-preset positions, when the current position of the electronic device is not within any position range; and
switching the current desktop to the default desktop, and displaying icons of the default desktop application group on a display device of the electronic device, when the current desktop is different from the default desktop.

5. The method according to claim 1, further comprising:
storing electronic maps in a storage device of the electronic device;
providing a drawing function to draw the plurality of position ranges on the electronic maps; and
in response to receiving drawn images, determining the plurality of position ranges by recognizing edges of the drawn images.

6. The method according to claim 1, further comprising:
setting the plurality of position ranges according to a preset radius and an inputted center of a circle having the preset radius.

7. An electronic device, comprising:
a display device;
a storage device;
a global position system (GPS);
at least one processor; and
a storage device storing a plurality of instructions, which when executed by the processor, causes the at least one processor to:
set a plurality of position ranges, and set a plurality of desktop application groups corresponding to the plurality of position ranges;
create a desktop corresponding to each of the plurality of desktop application groups;
acquire position information of the electronic device from the GPS;
determine a current position of the electronic device according to the acquired position information;
determine a position range that the current position is in, when the current position is determined to be in one of the plurality of position ranges;
determine a desktop application group and a desktop corresponding to the determined position range of the electronic device using the processor; and
when the determined desktop is different from a current desktop of the electronic device, switch the current desktop to the determined desktop, and display icons of the determined desktop application group on the determined desktop of the electronic device.

8. The electronic device according to claim 7, wherein the at least one processor further:
sets an updating frequency, and determine whether the current position of the electronic device is changed according to the updating frequency and refreshed position information of the electronic device acquired from the GPS.

9. The electronic device according to claim 7, wherein the at least one processor further:
sets a default desktop application group corresponding to non-preset positions that are not within the plurality of position ranges; and
sets a default desktop corresponding to the default desktop application group.

10. The electronic device according to claim 9, wherein the at least one processor further:
determines that the electronic device is located at the non-preset positions, when the current position of the electronic device is not within any position range; and
switches the current desktop to the default desktop, and display icons of the default desktop application group on a display device of the electronic device, when the current desktop is different from the default desktop.

11. The electronic device according to claim 7, wherein the at least one processor further:
stores electronic maps in a storage device of the electronic device;
provides a drawing function to draw the plurality of position ranges on the electronic maps; and
in response to receiving drawn images, determines the plurality of position ranges by recognizing edges of the drawn images.

12. The electronic device according to claim 7, wherein the at least one processor further:
sets the plurality of position ranges according to a preset radius and an inputted center of a circle having the preset radius.

13. A non-transitory storage medium having stored thereon instructions that, when executed by a processor of an electronic device, causes the electronic device to perform a method for switching desktops of an electronic device, the electronic device comprising a global position system (GPS), the method comprising:
setting a plurality of position ranges, and setting a plurality of desktop application groups corresponding to the plurality of position ranges;
creating a desktop corresponding to each of the plurality of desktop application groups;
acquiring position information of the electronic device from the GPS;
determining a current position of the electronic device according to the acquired position information;
determining a position range that the current position is in, when the current position is determined to be in one of the plurality of position ranges;
determining a desktop application group and a desktop corresponding to the determined position range of the electronic device using the processor; and
when the determined desktop is different from a current desktop of the electronic device, switching the current desktop to the determined desktop, and displaying icons of the determined desktop application group on the determined desktop of the electronic device.

14. The non-transitory storage medium according to claim 13, wherein the method further comprises:
setting an updating frequency, and determining whether the current position of the electronic device is changed according to the updating frequency and refreshed position information of the electronic device acquired from the GPS.

15. The non-transitory storage medium according to claim 13, wherein the method further comprises:
setting a default desktop application group corresponding to non-preset positions that are not within the plurality of position ranges; and
setting a default desktop corresponding to the default desktop application group.

16. The non-transitory storage medium according to claim 15, wherein the method further comprises:
determining that the electronic device is located at the non-preset positions, when the current position of the electronic device is not within any position range; and
switching the current desktop to the default desktop, and displaying icons of the default desktop application group on a display device of the electronic device, when the current desktop is different from the default desktop.

17. The non-transitory storage medium according to claim 13, wherein the method further comprises:
storing electronic maps in a storage device of the electronic device;
providing a drawing function to draw the plurality of position ranges on the electronic maps; and
in response to receiving drawn images, determining the plurality of position ranges by recognizing edges of the drawn images.

18. The non-transitory storage medium according to claim 17, wherein the method further comprises:
setting the plurality of position ranges according to a preset radius and an inputted center of a circle having the preset radius.
